(19) United States
(12) Patent Application Publication
(10) Pub. No.: US 2012/0141305 A1
(43) Pub. Date: Jun. 7, 2012

(54) Stay Rod for a High Pressure Oil Field Pump

(76) Inventors: R. Scott Landers, Fort Worth, TX (US); W. H. Barnett, Fort Worth, TX (US)

(21) Appl. No.: 12/959,114

(22) Filed: Dec. 2, 2010

(51) Int. Cl. F04B 19/00; F16B 35/00

(52) U.S. Cl. 417/360; 411/379

(57) ABSTRACT

A stay rod connects a power end to a fluid end of a high pressure well service pump where the pump has a pump motor face on a power end which is spaced apart from a joining face of a fluid end by the stay rods. The stay rods each have an elongated unitary body having first threaded end which is sized to be received in a mating threaded opening provided in the motor face of the power end of the pump and a second opposing threaded end which is sized to be received in a mating opening provided on the joining face of the fluid end of the pump. The intermediate portion is of a greater relative diameter than either of its first and second threaded ends and is provided with a series of elongated flats which begin at the approximate juncture between a shoulder joining the second threaded end and extending in the direction of a shoulder joining the first threaded end. Each flat forms a torque surface for engagement by a torque wrench for torquing and installing the stay rod.

### BACKGROUND OF THE INVENTION

1. Field of the Invention

The present invention relates generally to components of high pressure pumps and, more specifically, to a stay rod used to hold the face of the power end of such a pump to the fluid end thereof in a high pressure oil field pump particularly useful in the well services industries.

2. Description of the Prior Art

High pressure pumps are used in a variety of industrial settings. One use for such pumps is in the oil and gas industries and, specifically to well service pumps of the type used in completion and stimulation operations including fracturing, cementing, acidizing, gravel packing, snubbing and similar operations. For example, hydraulic well fracturing treatments are well known and have been widely described in the technical literature dealing with the present state of the art in well drilling, completion and stimulation operations. In a typical hydraulic fracturing operation, the subterranean well strata is subjected to tremendous pressures in order to create “fractures” of the strata to enable an increased flow of oil or gas reserves, ultimately to be produced to the well surface. The pressures are created by a high pressure pump located at the well surface.

A commercially available example of such a pump of this general type is marketed by Weir Oil and Gas as the TWS 2250HD™ Triplex Pump used primarily for well fracturing operations. Another pump in the same model line is the TWS 600S™ Series Pump. This pump is advertised as being a versatile small footprint pump that can perform a variety of duties for the well service industry including cementing, acidizing, gravel packing and snubbing. Various other manufacturers also make high pressure pumps of the type under consideration and the above models are given by way of example only.

There have been made advances made in recent years to high pressure pumps of the type described. For example, the TWS 600S™ Series Pump mentioned above is described in the literature as having an “offset crankshaft/cross head design” which is said to reduce the load on both the crosshead and crosshead guides as well as the main roller bearings supporting the crankshaft. However, despite the various advances over the years in the manufacturing arts for such pump designs, there continue to exist certain problem points. One of these problem areas in the design of such pumps concerns the present design of the stay rods which are used to connect the power end of the pump motor to the fluid end of the pump. These stay rods are subjected to large stresses and strains which can result in break points, in the case of the present stay rod designs. The ergonomics of the present stay rod designs also leave much to be desired.

It is accordingly an object of the present invention to provide an improved stay rod design which eliminates many of the shortcoming and deficiencies of the stay rods presently used in the industry for high pressure pumps of the type under consideration.

### SUMMARY OF THE INVENTION

The present invention has as its general object to provide improvements in the design of stay rods of the type used as components of high pressure pumps used in the oil field industry and, particularly, in the well services industry. The particular design feature towards which the present invention is directed is an improved stay rod used to connect a power end to a fluid end of a high pressure well service pump. Pumps of this type have a pump motor face on the power end which is spaced apart from a joining face of the fluid end by a plurality of stay rods.

The improved stay rod of the invention includes an elongated unitary body having first threaded end which is sized to be received in a mating threaded opening provided in the motor face of the power end of the pump and a second opposing threaded end which is sized to be received in a mating opening provided on the joining face of the fluid end of the pump. The elongated unitary body also has an intermediate body portion which is of a greater relative diameter than either of the first and second threaded ends thereof. The intermediate body portion is joined by a shoulder at either of two opposing ends thereof to the first and second opposing threaded ends. The intermediate body portion is provided with a series of elongated flats which begin at the approximate juncture between the shoulder joining the second threaded end and which extend in the direction of the shoulder joining the first threaded end. Each of the flats forms a torque surface for engagement by a torque wrench for torquing and installing the stay rod in one of the threaded openings provided in the motor face of the power end of the pump.

Preferably, the elongate body portion of the stay rod is provided with a knurled end region adjacent the shoulder joining the first threaded end, so that the stay rod can be more easily gripped in the presence of grease. Also, the flats provided on the intermediate body portion are preferably tapered and run out in the direction of the first threaded end. In one version of improved stay rod of the invention, there are six flats, forming a hex torque region for the stay rod.

In the preferred form of the invention, the intermediate body portion itself tapers slightly from the shoulder provided at the second threaded end to the shoulder provided at the first threaded end. In the most preferred design, the tapered intermediate body portion is at all points along the length thereof at least about twice the diameter of the diameter of the second threaded end.

The previously described improved stay rod is used in a high pressure well services pump, as described. A typical pump of this design is capable of developing on the order of 2250 horse power in the case of a three cylinder pump motor and 2400 horse power in the case of a five cylinder pump motor. The pump is used in a well servicing operation such as a fracturing, acidizing, cementing, gravel packing or snubbing operation.

Additional objects, features and advantages will be apparent in the written description which follows.

### BRIEF DESCRIPTION OF THE DRAWINGS

FIG. 1 is a simplified perspective view of a high pressure pump of the type which uses the improved stay rod of the invention.

FIG. 2 is a side, perspective view of the improved stay rod of the invention.

FIG. 3 is an end view of the stay rod of FIG. 2, taken along lines 3-3 in FIG. 2.

FIG. 4 is a view similar to FIG. 2, but of a prior art stay rod which the present stay rod is intended to replace.

### DETAILED DESCRIPTION OF THE INVENTION

The preferred version of the invention presented in the following written description and the various features and advantageous details thereof are explained more fully with reference to the non-limiting examples included in the accompanying drawings and as detailed in the description which follows. Descriptions of well-known components and processes and manufacturing techniques are omitted so as to not unnecessarily obscure the principle features of the invention as described herein. The examples used in the description which follows are intended merely to facilitate an understanding of ways in which the invention may be practiced and to further enable those skilled in the art to practice the invention. Accordingly, the examples should not be construed as limiting the scope of the claimed invention.

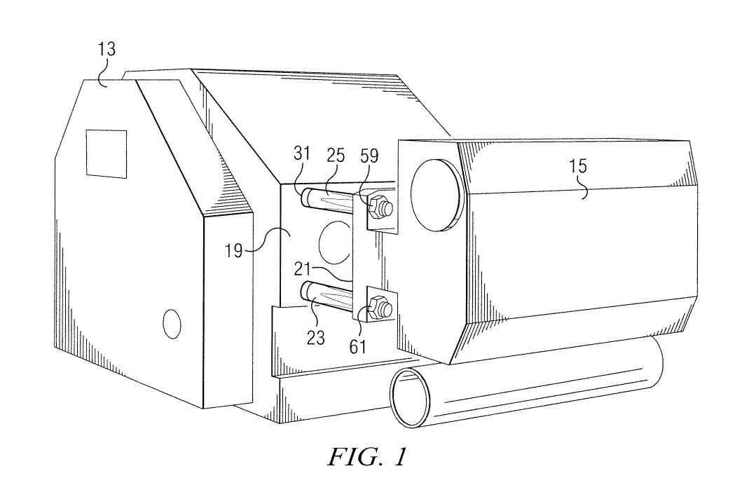

Turning first to FIG. 1, there is shown a representative example of a “high pressure oil field pump” of the type under consideration. These pumps are often referred to as “Triplex” or “Quintiplex” pumps, depending upon the number of cylinders. Such pumps have been used for many years for a variety of tasks and are well known in the relevant oil field arts. As briefly described in the background discussion, one commercially available example of such a pump of this general type is marketed by Weir Oil and Gas as the TWS 2250HD™ Triplex Pump used primarily for well fracturing operations. The published specifications for this pump are:

Rated Max Brake HP: 2,250 BHP (1,641 Kw)

Maximum Rod Load: 238,570 Lbs. (108,214 kg)

Stroke Length: 8″ (203.2 mm)

Gear Ratio: 6.353:1

Length: 89¾″ (2,280 mm)

Width: 59¾″ (1,518 mm)

Height: 44¼″ (1,124 mm)

Weight Dry (Approx.): 11,750# (5,330 kg)

This type of pump design is capable of developing on the order of 2250 horse power in the case of a three cylinder pump motor and 2400 horse power in the case of a five cylinder pump motor. Another pump in the same line is the TWS 600S™ Series Pump. This pump is more specifically directed toward cementing, acidizing, gravel packing and snubbing operations.

With reference now to FIG. 1 of the drawings, there is shown, in simplified fashion, a typical high pressure oil field pump designated as 11. The detailed workings of the pump 11 can be obtained from the Weir Oil and Gas website and other sources. The pump 11 has two principal parts, the “power end” and motor 13 and the “fluid end” 15. The power end houses a motor which powers a series of piston cylinders which provide the motive force used to drive the particular fluid being pumped through the internal chambers (not shown) of the fluid end 15.

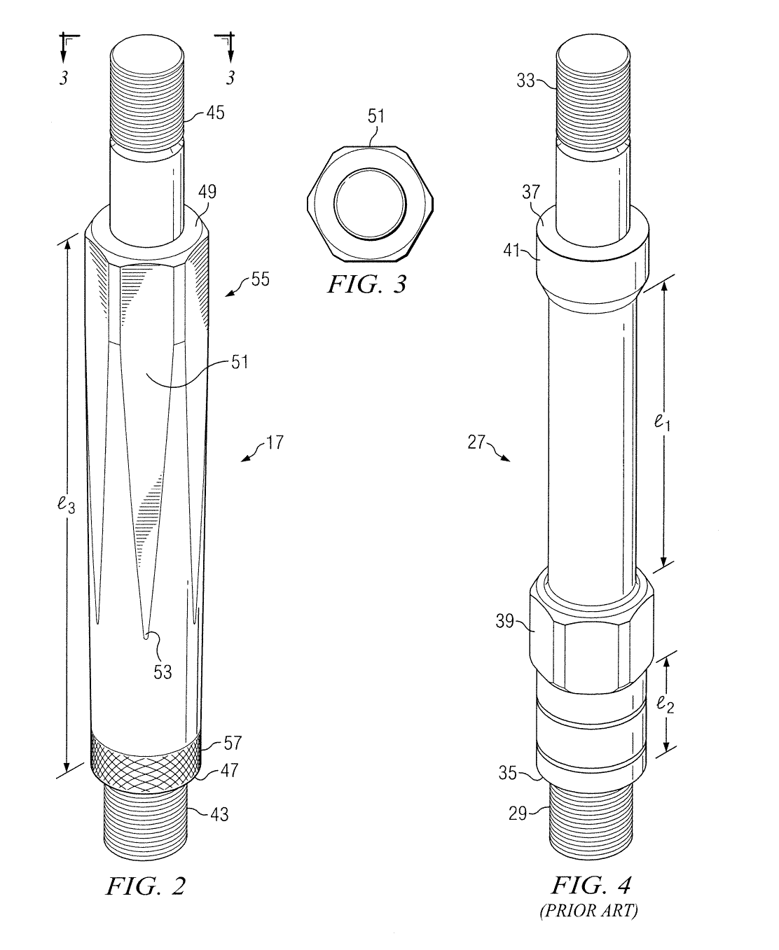

The improved stay rod of the invention (shown as 17 in FIG. 2) is used to connect the power end 13 to the fluid end 15 of the high pressure well service pump 11. As will be appreciated from FIG. 1, the pump 11 has a pump motor face 19 on the power end of the pump, the face 19 being arranged generally perpendicular to a surrounding support substrate. The face 19 of the power end 13 is spaced apart from a joining face 21 of the fluid end 15 by a plurality of stay rods (such as the stay rods 23, 25 shown in FIG. 1).

A number of differences in the design of the improved stay rod of the invention will be immediately apparent from the illustration of a standard, prior art stay rod, such as the stay rod illustrated generally as 27 in FIG. 4. The prior art stay rod has an elongated unitary body having first threaded end 29 which is sized to be received in a mating threaded opening (such as opening 31 in the motor face 19 in FIG. 1) provided in the power end of the pump and a second opposing threaded end 33 which is sized to be received in a mating opening provided on the joining face 21 of the fluid end 15 of the pump. A pair of shoulders 35, 37 adjacent the opposing threaded ends 29, 33 generally define an intermediate body portion of the stay rod. The length of the intermediate body shown as “l₁” in FIG. 4 is of a relatively smaller outer diameter than the diameter of a hex region 39 at one end thereof and of an oppositely arranged flared region 41 at an opposite end thereof A cylindrical region, designated as “l₂” in FIG. 4, connects the hex region 39 to the first threaded region 29.

There were a number of problem areas in the prior art design shown in FIG. 4. For one thing, the region of reduced diameter shown as “l₁” in FIG. 4 constituted a region of increased break points when the stay rod was placed into service on a high pressure oil field pump, such as the pump 11 in FIG. 1. Another less than optimal design feature concerns the placement of the hex region 39. During the manufacture of the pump l₁, the threaded end 29 of the stay rod is first installed in a mating opening on the face 19 of the power end 13 of the pump. The stay rod is installed using a conventional hydraulic torque wrench capable of delivering on the order of 1000 ft. lbs. of torque to the stay rod. Because of the location of the hex region 39, adjacent the first threaded end 29, it was necessary to bring the engagement surface of the torque wrench down almost the entire length of the stay rod in order to torque and install the stay rod on the power end in the case of the prior art stay rod shown in FIG. 4.

The improved stay rod of the invention is illustrated in FIGS. 2 and 3 of the drawings. It will be apparent in comparing FIGS. 2 and 4 that the improved stay rod, designated as 17 in FIG. 2, also constitutes an elongated unitary body having first threaded end 43 which is sized to be received in a mating threaded opening provided in the motor face 19 of the power end 13 of the pump and a second opposing threaded end 45 which is sized to be received in a mating opening provided on the joining face 21 of the fluid end 15 of the pump.

However, it will also be appreciated from a comparison of the stay rods in FIGS. 2 and 4 that the stay rod 17 of the invention has an intermediate body portion (designated as “l₃” in FIG. 2) which is of a greater relative diameter than either of the first and second threaded ends 43, 45, thereof The increase in relative diameter of the intermediate body portion of the improved stay rod decreases the likelihood of any break point existing in this portion of the stay rod in use. As will also be apparent in the illustration in FIG. 2, the intermediate body portion “l₃” is joined by a shoulder 47, 49 at either of the opposing ends thereof to the first and second opposing threaded ends 43, 45. The threaded end can be, for example, a 2 inch thread with 8 threads per inch. The threaded end 45 can be, for example, a 1¾ inch thread with 8 threads per inch.

In the preferred form of the invention illustrated in FIG. 2, the intermediate body portion “l₃” itself tapers slightly from the shoulder 49 provided at the second threaded end to the shoulder 47 provided at the first threaded end 43. In one exemplary form of the stay rod of the invention, the intermediate body portion “l₃” tapers from a maximum outer diameter of approximately 3 inches adjacent the shoulder 45 to a maximum outer diameter of about 2.65 inches adjacent the shoulder 47. The threaded end 45 has a maximum outer diameter of approximately 1.75 inches whereas the threaded end 43 has a maximum outer diameter of approximately 1.85 inches. In the example illustrated, the tapered intermediate body portion “l₃” is at all points along the length thereof significantly greater in outer diameter than the outer diameter of the second threaded end 45, i.e., 1.85 inches divided by 3.00 inches equals 0.62 or approximately a 62% increase.

The intermediate body portion is also provided with a series of elongated flats (such as flat 51 shown in FIG. 2) which begin at the approximate juncture between the shoulder 49 joining the second threaded end 45 and extending in the direction of the shoulder 47 joining the first threaded end 43. The flats 51 form converging surfaces which converge downwardly from the second threaded end 45 to arrive at a distal point 53. In other words, the flats provided on the intermediate body portion are tapered and run out in the direction of the first threaded end. Each of the flats 51 forms a torque surface for engagement by a torque wrench for torquing and installing the stay rod in one of the threaded openings (31 in FIG. 1) provided in the motor face of the power end of the pump.

The number of flats 51 can vary depending upon the pump design and other factors. The stay rod shown in FIGS. 2 and 3 has six flats which form a hex torque surface (see FIG. 3) for the stay rod. It should be noted that the resulting hex torque surface (shown generally at about 55 in FIG. 2) moves the point at which the torque wrench engages the stay rod much closer to the initially free threaded end 45 during the manufacture and assembly of the pump 11. This improves the ergonomic characteristics of the stay rod and results in an improved ease of assembly.

The particular preferred design of the stay rod of the invention shown in FIG. 2 also features an elongate body region which has a knurled end region 57 adjacent the shoulder 47 joining the first threaded end 43, so that the stay rod can be more easily gripped in the presence of grease.

The improved stay rod of the invention 17 can be used in assembling the fluid end 15 to the power motor end 13 of a high pressure pump, such as the pump 11 shown in FIG. 1. In the order of assembly of the fluid end to the power end, the improved stay rod is first installed on the face 19 of the power end by inserting the first threaded end 43 in the mating threaded opening 31 of the pump power end. The knurled surface 57 provides an improved gripping surface for the initial installation of the stay rod in the threaded opening 31. The stay rod 17 is then driven into position with a convention hydraulic torque wrench by locating the engagement surface of the torque wrench on the hex surface 55 adjacent the second threaded end 45. As has been mentioned, the location of the hex torque surface 55 adjacent the initially free end of the stay rod 17 provides improved ease in locating the engagement surface of the torque wrench on the stay rod.

Once the stay rod has been driven into position on the power end face 19, the fluid end 15 can be positioned on the stay rod 17 by inserting the second threaded end 45 of the stay rod within suitable openings (such as the opening located at about 59 in FIG. 1). There is typically provided a series of U-shaped holes on the fluid end for receiving the second threaded end 45 of the stay rod. The stay rod is then fixed to the fluid end 15 by means of a series of nuts. In a typical pump manufacture, some 12 to 20 stay rods of the type described will be required for a 3 or 5 cylinder high pressure pump where the pump is capable of developing on the order of 2250 horse power in the case of a three cylinder pump motor and 2400 horse power in the case of a five cylinder pump.

The improved stay rod of the invention has several advantages over the designs of the prior art. The improved stay rod has a “beefed up” intermediate region which is stronger than the prior art design and thus is less likely to break in this region when subjected to the tremendous stresses and strains encountered in the normal operation of the pump. The newly designed flat surfaces provided on the intermediate region of the stay rod move the point of engagement for the torque wrench in the direction of the second threaded end (the initially free end) of the stay rod, so that the length of the path of travel of the toque wrench is reduced. The knurled region provided adjacent the first threaded end of the stay rod provides an improved grip region for the stay rod, even in the presence of grease.

While the invention has been shown in only one of its forms, it is not thus limited but is susceptible to various changes and modifications without departing from the spirit thereof, as described in the claims which follow.

What is claimed is:

1. An improved stay rod used to connect a power end to a fluid end of a high pressure well service pump, the pump having a pump motor face on the power end which is spaced apart from a joining face of the fluid end by a plurality of stay rods, the improved stay rod of the invention comprising:
an elongated unitary body having first threaded end which is sized to be received in a mating threaded opening provided in the motor face of the power end of the pump and a second opposing threaded end which is sized to be received in a mating opening provided on the joining face of the fluid end of the pump;
the elongated unitary body also having an intermediate body portion which is of a greater relative diameter than either of the first and second threaded ends thereof, the intermediate body portion being joined by a shoulder at either of two opposing ends thereof to the first and second opposing threaded ends, the intermediate body portion being provided with a series of elongated flats which begin at the approximate juncture between the shoulder joining the second threaded end and extending in the direction of the shoulder joining the first threaded end, each of the flats forming a torque surface for engagement by a torque wrench for torquing and installing the stay rod in one of the threaded openings provided in the motor face of the power end of the pump.

2. The improved stay rod of claim 1, wherein the elongate body portion of the stay rod is provided with a knurled end region adjacent the shoulder joining the first threaded end, so that the stay rod can be more easily gripped in the presence of grease.

3. The improved stay rod of claim 1, wherein the flats provided on the intermediate body portion are tapered and run out in the direction of the first threaded end.

4. The improved stay rod of claim 3, wherein there are six flats, forming a hex torque region for the stay rod.

5. The improved stay rod of claim 1, wherein the intermediate body portion itself tapers slightly from the shoulder provided at the second threaded end to the shoulder provided at the first threaded end.

6. The improved stay rod of claim 5, wherein the tapered intermediate body portion is at all points along the length thereof at least about 60% greater diameter than the diameter of the second threaded end.

7. A high pressure well services pump, the pump having a power end and a fluid end, the pump having a pump motor face on the power end which is spaced apart from a joining face of the fluid end by a plurality of stay rods, the improvement comprising:
an improved stay rod for joining the power end of the pump to the fluid end thereof, the improved stay rod having an elongated unitary body having first threaded end which is sized to be received in a mating threaded opening provided in the motor face of the power end of the pump and a second opposing threaded end which is sized to be received in a mating opening provided on the joining face of the fluid end of the pump;
the elongated unitary body also having an intermediate body portion which is of a greater relative diameter than either of the first and second threaded ends thereof, the intermediate body portion being joined by a shoulder at either of two opposing ends thereof to the first and second opposing threaded ends, the intermediate body portion being provided with a series of elongated flats which begin at the approximate juncture between the shoulder joining the second threaded end and extending in the direction of the shoulder joining the first threaded end, each of the flats forming a torque surface for engagement by a torque wrench for torquing and installing the stay rod in one of the threaded openings provided in the motor face of the power end of the pump.

8. The improved high pressure well services pump of claim 7, wherein the pump is capable of developing on the order of 2250 horse power in the case of a three cylinder pump motor.

9. The improved high pressure well service pump of claim 7, wherein the pump is used in a well servicing operation selected from the group consisting of fracturing, acidizing, cementing, gravel packing and snubbing.

10. The improved high pressure well service pump of claim 7, wherein the elongate body portion of the stay rod is provided with a knurled end region adjacent the shoulder joining the first threaded end, so that the stay rod can be more easily gripped in the presence of grease.

11. The improved high pressure well service pump of claim 7, wherein the flats provided on the intermediate body portion are tapered and run out in the direction of the first threaded end.

12. The improved high pressure well service pump of claim 11, wherein there are six flats, forming a hex torque region for the stay rod.

13. The improved high pressure well service pump of claim 7, wherein the intermediate body portion itself tapers slightly from the shoulder provided at the second threaded end to the shoulder provided at the first threaded end.
